(19) United States
(12) Patent Application Publication
(10) Pub. No.: US 2003/0018526 A1
(43) Pub. Date: Jan. 23, 2003

(54) Method and system for advertising offers

(76) Inventor: Ernest Johann Fantner, Vienna (AT)

Correspondence Address: Corporate Patent Counsel, Philips Electronics North America Corporation, 580 White Plains Road, Tarrytown, NY, 10591-5198, US

(21) Appl. No.: 10/048,041

(22) PCT Filed: May 10, 2001
(86) PCT No.: PCT/EP01/05318

(30) Foreign Application Priority Data
May 31, 2000 (EP) 00890179.5

(51) Int. Cl. G06F 17/60

(52) U.S. Cl. 705/14

(57) ABSTRACT

A system (1) for advertising offers, which can be presented by advertising objects (7, 8, 9, 10), which are shown on an advertising surface (6) erected at a certain location, has input means (11) which are assigned to the advertising surface (6) and which are provided for inputting visitor information, while, additionally, evaluation means (24) are provided which are used for evaluating the visitor information input by the input means (11) and received by the evaluation means (24) and for generating result information which represents a measure for the commercial effect of the advertising objects (7, 8, 9, 10) and which can be output by output means (25).

The invention relates to a method and a system for advertising offers which can be presented with the aid of advertising objects, which objects can be perceived on an advertising surface provided at a location visited by visitors.

Such a method and such a system of the type defined in the opening paragraph are generally known in a variety of variants of embodiment. With such a known system a billboard is provided as an advertising surface, while a plurality of advertising posters by which several offers are advertised are stuck to the billboard. With the known system it is a given fact that it is only possible to convey an advertising message to the visitors or viewers respectively, of a billboard, while the provider of the known system and the customers of the provider of the known system hope to achieve a most efficient and large commercial effect with the advertising posters provided as advertising objects. With the known system and with the known method the commercial effect and a success resulting therefrom can only be measured by means of a comparison between the results achieved before the presentation of the advertising posters and the result achieved after the presentation of the advertising posters. This fact represents an unsatisfactory situation which deserves of improvement, because the result of the presentation of advertising objects cannot be established until after a relatively long time space.

It is an object of the invention to avoid the afore-mentioned facts and provide an improved method and an improved system in accordance with the type defined in the opening paragraph, which offer considerably more and improved technical possibilities.

For achieving the object defined above, a method of the type defined in the opening paragraph and in accordance with the invention is characterized by the steps stated hereinafter, that is, a) assigning electronic input means to the advertising surface and b) receiving visitor information input by the input means, which information is triggered by visitors to the location of the advertising surface and c) evaluating the received visitor information and generating a measure for result information representing the commercial effect of the advertising objects present on the advertising surface and d) outputting the result information.

For achieving the object defined above, furthermore a system of the type defined in the opening paragraph according to the invention is characterized by the system portions stated hereinafter, that is, electronic input means which are assigned to the advertising surface and are provided for inputting visitor information, which visitor information can be called up by visitors to the location of the advertising surface, and evaluation means which are provided for evaluating the visitor information input by the input means and received via the evaluation means, and for generating a measure for result information representing the commercial effect of the advertising objects present on the advertising surface, and output means for outputting the result information.

Providing the features according to the invention achieves in a simple manner and with only simple and cost-effective technical means that the technical and non-technical possibilities, which can be achieved with a method and system according to the invention, are by far beyond the possibilities which can be achieved with the known method and system. With a method according to the invention and with a system according to the invention, the features according to the invention provide that conclusions drawn from the presented advertising objects can be realized, that is practically immediately after a reaction of the users or viewers of displayed advertising objects, so that the efficiency of the commercial effect of displayed advertising objects can be established in a very fast manner and, as a result, a very fast adaptation or a very fast exchange of advertising objects can be carried out in a purposeful manner.

It should be observed that in conjunction with a method according to the invention and a system according to the invention both advertising posters and commercials or advertising pictures displayed on a picture screen, but also acoustically reproduced advertising messages, are possibilities.

For a method according to the invention and a system according to the invention it has proved to be highly advantageous when the visitor information is in the form of spoken information, because such spoken information is extremely well-suited for determining the gender and/or age of visitors or viewers respectively, of an advertising surface, so that the age-related or gender-related effect of an advertising system according to the invention can be established in a simple manner and a necessary change, if any, of the advertising objects can be recognized at a very early stage. It has, however, also proved to be advantageous when the visitor information is formed by character information, which is input by means of a keyboard, or when the visitor information is formed by card information, which is rendered available by means of a chip card reader, so that then the commercial effect of an advertising surface on, for example, credit card users can be established. It has further proved to be advantageous when the electronic input means are arranged for inputting so-called e-malls, because then the visitor information can be derived from the information representing an e-mail, which information is highly suitable for establishing result information that represents the countries of origin of the visitors or viewers respectively, of an advertising surface, so that the commercial effect of an advertising surface on viewers from different countries of origin can be established and the advertising objects can readily be adapted to the viewers' countries of origin.

Result information can be output, for example, by printing it with a printer, or by displaying it with a display device, or by outputting it in the form of a data file. It has turned out to be highly advantageous when in a system according to the invention controllable change means are provided with the aid of which advertising objects presented on an advertising surface are automatically changed or exchanged in response to the result information obtained. This can be simply realized particularly when the offers are electronically presented by means of advertising objects, for example, with the aid of LCD picture screens provided on an advertising surface.

In a system according to the invention it has turned out to be highly advantageous when a billboard of cylindrical shape is provided as an advertising surface and when the electronic input means are provided in the cylindrically shaped billboard. Such an embodiment may be realized very similarly to a so-called advertising column.

The aspects stated above and further aspects of the invention follow from the example of embodiment to be described hereinafter and are explained with reference to this example of embodiment.

The invention will be described in more detail with reference to an example of embodiment shown in the drawing, to which, however, the invention is not restricted. In the drawing:

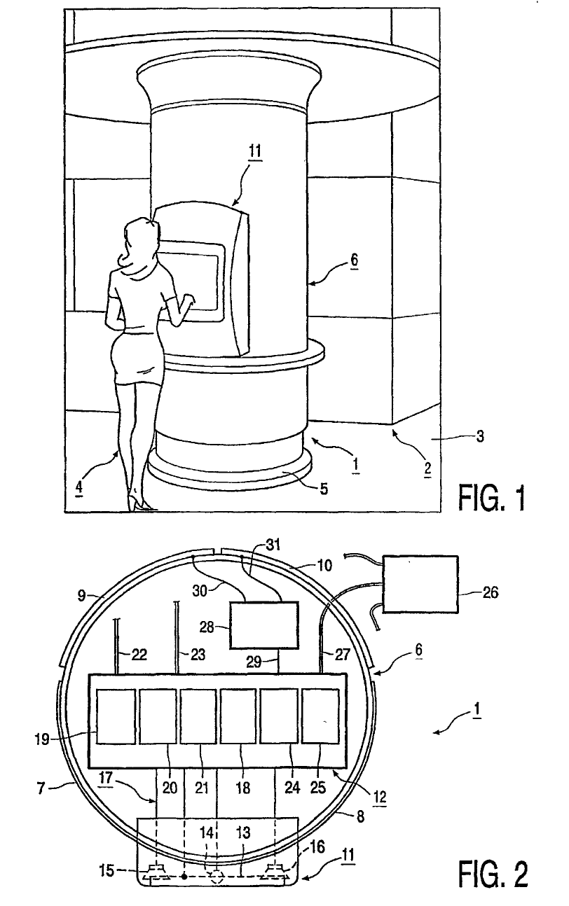

FIG. 1 gives in a pictorial representation of a system for advertising offers in accordance with an example of embodiment of the invention,

FIG. 2 shows in diagrammatic manner the system as shown in FIG. 1 in a plan view with a removed cover of the system as shown in FIG. 1,

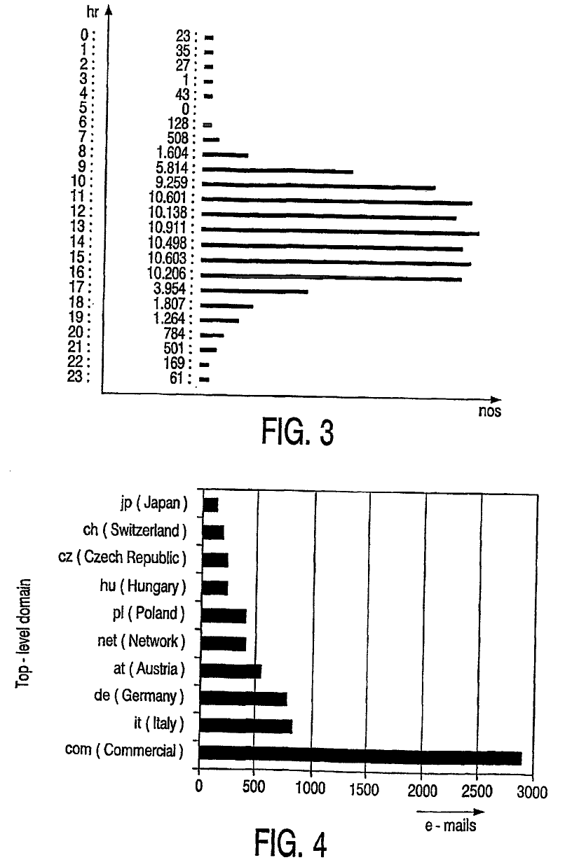

FIG. 3 shows a print with result information representing the number of visitors who have visited the location of the system shown in FIGS. 1 and 2 in successive time spaces and

FIG. 4 shows a print of result information representing the countries of origin of the visitors who have visited the location of the system as shown in FIGS. 1 and 2 in one time space.

The FIG. 1 shows in a visual three-quarter view a system 1 for advertising offers, which is erected near the corner of a house 2 on a sidewalk 3, while a visitor or a viewer 4 respectively, of the system 1 is shown standing in front of the system 1.

The system 1 has a base 5, from which an advertising surface 6 rises, which is formed by a billboard 6. In the present case the billboard 6 has a cylindrical shape. Exchangeable advertising posters, which, however, are not shown in the FIG. 1, can be stuck to the billboard 6 as advertising objects. Different offers can be presented with the aid of the advertising objects arranged as advertising posters.

A first advertising poster 7 and a second advertising poster 8 are affixed to the billboard 6 provided as an advertising surface 6 as is illustrated in FIG. 2, in that the two advertising posters 7 and 8 are stuck to the billboard 6. Furthermore, a first electronic display device 9 and a second electronic display device 10 are provided on the billboard 6. Different advertising pictures can be displayed by the two electronic display devices 9 and 10, which is advantageous in that the offers presented on the billboard 6 with the aid of the two electronic display devices 9 and 10 can easily be changed or exchanged.

The system 1 advantageously comprises electronic input means 11, which are assigned to the advertising surface 6 and are provided for inputting visitor information or viewer information respectively, which visitor information can be triggered by visitors to the location where the advertising surface 6 is erected. The input means are provided in the cylindrical billboard 6. Furthermore, the system 1 comprises an electronic device 12, which is realized, in essence, with the aid of a personal computer. The electronic device 12 is installed in the interior of the advertising surface 6.

The input means 11 comprise a touch-sensitive picture screen 13 by which input information can be input as user information. The picture screen 13 at the same time represents an output unit by which picture and/or text information can be reproduced. The input means 11 further include speech signal input means 14, which are formed, in essence, by a microphone. The input means 11 further contain two loudspeakers 15 and 16 by which sound signals can be reproduced. The picture screen and the speech signal input means 14 as well as the two loudspeakers 15 and 16 are connected to the electronic device 12 via electrically conducting links 17, which are shown only schematically.

The electronic device 12 is instrumental in forming speech signal recognition means 18, which are connected to the speech signal input means 14 and, together with the speech signal input means 14, form part of the input means 11. By means of the speech signal recognition means 18 can be generated speech signals uttered by users and the respective speech information cm be fed to the electronic device 12. This speech information also represents visitor information.

Furthermore, the electronic device 12 is also instrumental in forming the telephone connection means 19, e-mail transmission means 20 and Internet access means 21. Telephone calls received via the speech signal input means 14 can be supplied to a telephone line 22 by the telephone connection means 19, which telephone line 22 is connected to a public telephone network. The e-mail transmission means 20 can apply e-mails, which are written by users with a keyboard provided on a touch-sensitive picture screen, to a server connection line 23 which is led to a server in known manner. The internet access means 21 can select an internet address fed by means of the touch-sensitive picture screen 13, during which operation a respective connection is then set up via the server connection line 23 by the internet access means 21, after which the information desired from the Internet is reproduced by the picture screen 13.

The electronic device 12 is further instrumental in forming evaluation means 24, which are provided for evaluating the visitor information input by the input means 11 and received by the evaluation means 24 and which evaluation means 24 are provided for generating a measure for the result information representing the commercial effect of the advertising objects 7, 8, 9 and 10 present on the advertising surface 6. Telephone number data can be applied to the evaluation means 24 by the telephone connection means 19. E-mail address information can be applied to the evaluation means 24 by the e-mail transmission means 20. Internet address information can further be applied to the evaluation means 24 by the Internet access means 21. Speech information can furthermore be applied to the evaluation means 24 by the speech signal recognition means 18. By using all this user information described above and with the aid of evaluation programs, the evaluation means 24 generate result information which—as already observed—represents a measure for the commercial effect of the advertising objects 7, 8, 9 and 10 present on the advertising surface 6 or the offers respectively, advertised thereby.

The evaluation means 24 are in the present case provided for determining the number of visitors who have visited in successive time spaces, for example, in successive hours of a day, the location of the advertising surface 6 within a time space of a holiday season, for example. The number of visitors can be determined with relatively much accuracy from the number of inputs for the input means. Furthermore, the evaluation means are used for determining the countries of origin of the visitors who have visited the location of the advertising surface 6 in a time space, for example, in a quarter year or in a year. The countries of origin of the visitors can be determined with relatively much accuracy from the e-mail target addresses sent by the visitors.

In the present case the evaluation means 24 are also arranged for determining the gender and/or age of the visitors who have visited the location of the advertising surface 6 in a time space, for example, in a day or in a month. The gender and/or age of the visitors can be determined with relatively much accuracy from the speech information derived from the uttered speech.

The evaluation means 24 are additionally arranged for—which is not separately shown in FIGS. 1 and 2—determining the visitors' judgement of advertising objects present on the advertising surface 6, who have visited the location of the advertising surface 6 in a time space, for example, of less than three days. Such an evaluation of the advertising objects may be made possible in a simple manner in that a presence sensor which senses the presence of a viewer in front of the respective advertising object and activates a timer by which the duration of presence of a viewer in front of the advertising object can be determined, is assigned to each advertising object. From the lingering time of the visitors in front of an advertising object may be drawn a conclusion about the quality or effect of the advertising object, so that the lingering time represents a measure for the commercial effect of an advertising object present on the advertising surface 6.

In the system 1 the electronic device 12 also accommodates transmission means 25 which form output means, with the aid of which the result information generated by the evaluation means 24 can be transmitted to an information center 26 via a data link 27. The information center 26 is shared here by a plurality of advertising surfaces 6, thus a plurality of advertising surfaces is assigned thereto. It is then possible to call up from the information center the result information generated in the system and process it in the information center.

In the system 1 are additionally provided controllable modification means 28 which can be controlled in dependence on the result information generated by the evaluation means 24 and applied to the modification means 28 via a link 29. The modification means 28 are connected on one side to the first electronic display device 9 via a first connection 30 and to the second electronic display device 10 via a second connection 31. The offers presented on the advertising surface 6 by advertising objects 9 and 10, thus by the two electronic display devices 9 and 10 via the two connections 30 and 31, can be modified or exchanged in dependence on the result information generated by the evaluation means 24.

Additionally, the system 1 can include a printer as output means, by which the generated result information can be printed out either in the form of a table or in bars. The result information may also be printed out in the information center 26 by means of a printer provided there.

FIG. 3 shows an example of such a printout. This printout shows the result information which represents the number of visitors who have visited in successive time periods, that is, in successive hours within a time space of five months, the location of the advertising surface 6 or of the system 1 as shown in FIGS. 1 and 2. As can be learnt from this printout, the number of visitors to the location at which the system 1 is installed has peak values between 10 a.m. and 4 p.m., whereas in other time sections there were hardly any visitors present. Form this finding there may be derived, for example, that in the time spaces in which there are practically no visitors to the location of the respective system, the electronic display devices 9 and 10 can be switched off.

FIG. 4 shows another printout. In this printout the result information is given which represents the countries of origin of the visitors who have visited and viewed the system 1 according to the FIGS. 1 and 2 in a time period of five months. In this printout are shown the countries of origin of the visitors, which countries of origin were determined in a simple manner from the e-mail target addresses of sent e-mails. From the diagram shown in FIG. 4 may be drawn the conclusion that with the system 1, with visitors coming from Japan, a commercial effect is hardly noticeable because the number of visitors coming from Japan is comparatively small. Therefore, in the system 1, with which the result information shown in FIG. 4 was obtained, the offers presented on the advertising objects 7, 8, 9 and 10 may rather be concentrated on visitors from Italy, Germany and Austria.

The invention is not restricted to the example of embodiment described above. The system according to the invention may also have a partially open cylindrical shape instead of a closed cylindrical shape. A system according to the invention may also have an advertising surface in the form of a flat billboard. A system according to the invention may also be equipped with a video camera which feeds a picture analysis device by which user information based on prerecorded pictures of users, can be generated that can be evaluated by the evaluation means.

1. A method of advertising offers which can be presented with the aid of advertising objects (7, 8, 9, 10), which objects (7, 8, 9, 10) can be perceived on an advertising surface (6) provided at a location (2) visited by visitors (4), which method is characterized by the steps stated below, that is to say
a) assigning electronic input means (11) to the advertising surface (6) and
b) receiving visitor information input by the input means (11), which information is triggered by visitors (4) to the location (2) of the advertising surface (6) and
c) evaluating the received visitor information and generating a measure for the result information representing the commercial effect of the advertising objects (7, 8, 9, 10) present on the advertising surface (6) and
d) outputting the result information.

2. A method as claimed in claim 1, characterized in that the visitor information is speech information, which corresponds to speech signals received by speech signal receiving means (14) and recognized by speech signal recognition means (18).

3. A method as claimed in claim 1, characterized in that the visitor information is input information input via a touch-sensitive picture screen (13).

4. A method as claimed in claim 1, characterized in that the result information represents the number of visitors (4) who have visited the location (2) of the advertising surface (6) in successive time spaces.

5. A method as claimed in claim 1, characterized in that the result information represents the countries of origin of the visitors (4) who have visited the location (2) of the advertising surface (6) in one time space.

6. A method as claimed in claim 1, characterized in that the result information represents the gender and/or age of the visitors (4) who have visited the location (2) of the advertising surface (6) in one time space.

7. A method as claimed in claim 1, characterized in that the result information represents an evaluation of advertising objects (7, 8, 9, 10) presented on the advertising surface (6) by the visitors (4) who have visited the location (2) of the advertising surface (6) in one time space.

8. A method as claimed in claim 1, characterized in that result information is output by the transmission to an information center (26) which is shared by a plurality of advertising surfaces (6).

9. A method as claimed in claim 1, characterized in that the offers presented on the advertising surface (6) with the aid of the advertising objects (7, 8, 9, 10) are modified or exchanged in dependence on the result information.

10. A system (1) for advertising offers which can be presented with the aid of advertising objects (7, 8, 9, 10), which objects (7, 8, 9, 10) can be perceived on an advertising surface (6) provided at a location (2) visited by visitors (4), which system is characterized by the system portions stated hereinafter, that is:
electronic input means (11) which are assigned to the advertising surface (6) and are provided for inputting visitor information, which visitor information can be triggered by visitors (4) to the location (2) of the advertising surface (6), and
evaluation means (24) which are provided for evaluating the visitor information input by the input means (11) and received via the valuation means (24), and for generating a measure for result information representing the commercial effect of the advertising objects (7, 8, 9, 10) present on the advertising surface (6), and
output means (25) provided for outputting the result information.

11. A system (1) as claimed in claim 10, characterized in that the input means (11) comprise speech signal input means (14) and speech signal recognition means (18), by which speech information corresponding to speech signals spoken by users (4) can be input as visitor information.

12. A system (1) as claimed in claim 10, characterized in that the input means (11) comprise a touch-sensitive picture screen (13) by which input information can be input as user information.

13. A system (1) as claimed in claim 10, characterized in that the evaluation means (24) are provided for determining the number of visitors (4) who have visited the location (2) of the advertising surface (6) in successive time spaces.

14. A system (1) as claimed in claim 10, characterized in that the evaluation means (24) are provided for determining the countries of origin of the visitors (4) who have visited the location (2) of the advertising surface (6) in one time space.

15. A system (1) as claimed in claim 10, characterized in that the evaluation means (24) are provided for determining the gender and/or age of the visitors (4) who have visited the location (2) of the advertising surface (6) in one time space.

16. A system (1) as claimed in claim 10, characterized in that the evaluation means (24) are provided for determining a judgement by the visitors (4) of advertising objects (7, 8, 9, 10) presented on the advertising surface (6), which visitors (4) have visited the location (2) of the advertising surface (6) in one time space.

17. A system (1) as claimed in claim 10, characterized in that the transmission means (25) are provided by which the generated result information can be transmitted to an information center (26) shared by a plurality of advertising surfaces (6).

18. A system (1) as claimed in claim 10, characterized in that controllable modification means (28) are provided which can be controlled in dependence on the result information and by which the offers presented on the advertising surface (6) by the advertising objects (9, 10) can be modified or exchanged in dependence on the result information.

19. A system (1) as claimed in claim 10, characterized in that the system (1) has a billboard (6) as an advertising surface (6) and in that exchangeable advertising posters (7, 8) can be stuck to the billboard (6) as advertising objects.

20. A system (1) as claimed in claim 10, characterized in that the billboard (6) has a cylindrical shape and in that the input means (11) are provided in the cylindrically shaped billboard (6).
